(19) United States
(12) Patent Application Publication
(10) Pub. No.: US 2018/0150458 A1
(43) Pub. Date: May 31, 2018

(54) USER TERMINAL DEVICE FOR PROVIDING TRANSLATION SERVICE, AND METHOD FOR CONTROLLING SAME

(71) Applicant: Samsung Electronics Co., Ltd., Suwon-si, Gyeonggi-do (KR)

(72) Inventor: Yoon-jin YOON, Yongin-si (KR)

(21) Appl. No.: 15/572,400

(22) PCT Filed: Jun. 22, 2016
(86) PCT No.: PCT/KR2016/006585

§ 371 Date: Nov. 7, 2017

(30) Foreign Application Priority Data
Jul. 30, 2015 (KR) 10-2015-0108233

(51) Int. Cl. G06F 17/28; H04W 4/12; G06F 3/0488; G06F 3/0346; G10L 13/04

(52) U.S. Cl. CPC G06F 17/289; H04W 4/12; H04W 88/02; G06F 3/0346; G10L 13/04; G06F 3/04883

(57) ABSTRACT

Provided is a user terminal device for providing a translation service. The user terminal device comprises: a communication unit for performing communication with an external device; a display for displaying messages transmitted and received by communication with the external device; a sensing unit for sensing a gesture for the user terminal device; and a processor for, if a preset gesture is sensed, providing a translation service for at least one message from among the displayed messages.

### TECHNICAL FIELD

The present disclosure relates to a user terminal device and a method for controlling the same, and more particularly, to a user terminal device for providing translation service and a method for controlling the same.

### BACKGROUND ART

With distribution of smart phones and development of the information and communication technology, instant message transmitting applications such as mobile messenger, social network service (SNS) or the like are expanded and users thereof are exponentially increased. With the services such as instant message transmitting applications and so on are actively implemented, even the general users need free communication with foreigners using different languages.

However, inconvenience is experienced due to language barrier when users of different languages are conversing with each other on the message transmitting applications. Conventionally, in order to translate messages transmitted and received in foreign languages, translation is performed by using separately installed translation applications or web pages providing translation service. However, these methods require works such as installing and implementing the translation applications, accessing web pages, or the like. Further, because each foreign language message should be copied and pasted in order to perform translation, problems such as user inconvenience and difficulty of continuing smooth conversation may occur.

Accordingly, in order to solve inconvenience mentioned above, a form of translation solution suitable for transmitted and received messages is required.

### DISCLOSURE

### Technical Problem

Accordingly, an object of the present disclosure is to provide a user terminal device for translating messages transmitted and received between user terminal devices and providing a result more conveniently and a method for controlling the same.

### Technical Solution

In order to accomplish the above-mentioned objects, the present invention provides a user terminal device for providing translation service, including a communication unit configured to perform communication with an external device, a display configured to display a message transmitted and received in a communication with the external device, a sensing unit configured to sense a gesture for the user terminal device, and a processor configured to provide the translation service for at least one of the displayed messages when a preset gesture is sensed.

Further, the processor may distinctively display the messages being transmitted and received on a message unit basis, and provide the translation service for the displayed messages on the message unit basis.

Further, in response to a touch gesture for at least one of the displayed messages being sensed, the processor may control such that a translated message of the message for which touch gesture is inputted is displayed in a preset language.

Further, in response to a touch gesture for the translated message being sensed, the processor may control such that the translated message for which the touch gesture is inputted is displayed in a source language before the translation.

Further, the touch gesture for the message may be a touch and drag in a first direction, and the touch gesture for the translated message may be a touch and drag in a second direction opposite the first direction.

Further, the processor may control such that, the message for which the touch gesture is inputted is replaced by the translated message and displayed, or the translated message is displayed together with the message for which the touch gesture is inputted.

Further, in response to a touch gesture for the translated message being input, the processor may control such that pronunciation information with respect to the translated message for which touch gesture is inputted may be displayed.

Further, in an embodiment, the user terminal device may further include a speaker and, in response to a touch gesture with respect to the pronunciation information being input, the processor may converts the pronunciation information for which the touch gesture is inputted into voice and outputs the converted voice through the speaker.

Further, in response to a motion gesture for the user terminal device being sensed, the processor may control such that all of the displayed messages may be translated into a preset language and displayed.

Further, the communication unit may perform communication with an external server for providing translation service, and the processor may controls such that at least one of the displayed message is transmitted to the external server, and a translated message of the at least one message received from the external server may be displayed.

Meanwhile, a control method of a user terminal device for providing translation service according to an embodiment is provided, which may include displaying a message transmitted and received in a communication with an external device, sensing a gesture for the user terminal device, and providing the translation service for at least one of the displayed messages.

Further, the displaying may include distinctively displaying the transmitted and received message on a message unit basis, and the providing the translation service may include providing the translation service for the displayed message on a message unit basis.

Further, in response to a touch gesture for at least one of the displayed messages being sensed, the providing the translation service may include displaying a translated message of the message for which touch gesture is inputted, in a preset language.

Further, in response to a touch gesture for the translated message being sensed, the providing the translation service may include displaying the translated message for which the touch gesture is inputted in a source language before translation.

Further, the touch gesture inputted for the message may be a touch and drag in a first direction, and the touch gesture inputted for the translated message may be a touch and drag in a second direction opposite the first direction.

Further, the providing the translation service may include replacing the message for which the touch gesture is inputted by the translated message and displaying a result, or displaying the translated message together with the message for which the touch gesture is inputted.

Further, in response to sensing a touch gesture inputted for the translated message, pronunciation information with respect to the translated message for which touch gesture is inputted may be displayed.

Further, in response to inputting of a touch gesture for the pronunciation information, the pronunciation information for which the touch gesture is inputted may be converted into voice, and the converted voice may be outputted through the speaker.

Further, in response to sensing a motion gesture inputted for the user terminal device, all of the displayed messages may be translated into a preset target language and displayed.

Further, the providing translation service may include transmitting at least one of the displayed messages to the external server, receiving a translated message with respect to at least one message from the external server, and displaying the received translated message.

### Advantageous Effects

According to the above various embodiments, a message transmitted and received between user terminal devices can be instantly translated, and communication between users using different languages from each other can be performed further facilitated.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram briefly illustrating a constitution of a user terminal device according to an embodiment;

FIG. 2 is a diagram illustrating a system in which a user terminal device in a communication with an external server performs translation according to an embodiment;

FIGS. 3 to 5 are diagrams provided to explain a touch gesture for translating messages according to an embodiment;

FIG. 6 is a diagram provided to explain a touch gesture for translating messages according to another embodiment;

FIG. 7 is a diagram provided to explain a method for displaying pronunciation information of a message according to an embodiment;

FIGS. 8 and 9 are diagrams provided to explain a motion gesture for translating all of displayed messages according to an embodiment;

FIG. 10 is a diagram provided to explain a touch gesture for translating messages posted on the social network service according to an embodiment;

FIG. 11 is a block diagram illustrating a constitution of a user terminal device in detail according to another embodiment; and

FIG. 12 is a flowchart provided to explain a method of a user terminal device according to an embodiment.

### BEST MODE

### Mode for the Invention

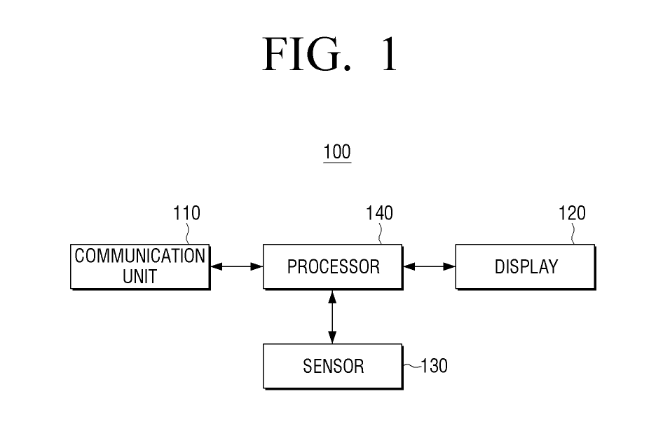

FIG. 1 is a block diagram briefly illustrating a constitution of a user terminal device according to an embodiment.

Referring to FIG. 1, the user terminal device 100 according to an embodiment includes a communication unit 110, a display 120, a sensing unit 130 and a processor 140.

The communication unit 110 is configured to perform communication with various types of external devices according to various types of communication methods. In an example, the external devices may include at least one among a messaging service providing server 200, a translation service providing server 300 and a counterpart user terminal device.

The communication unit 110 may transmit a message written on the user terminal device 100 or receive a message from the counterpart user terminal device or the messaging service providing server 200 providing the message transmitting and receiving services, in a communication with the counterpart user terminal device or the messaging service providing server 200. The messaging service providing server 200 refers to a server for providing service to relay message transmission and reception with respect to the counterpart user terminal device.

Further, the communication unit 110 may perform communication with the translation service providing server 300. The communication unit 110 may generate a translation request message to request translation of a message selected by a user into a language according to preset translation options, and transmit the generated translation request message to the translation service providing server 300. The communication unit 110 may receive the translated message of the selected message from the translation service providing server 300.

The communication unit 110 may include Wi-Fi chip, Bluetooth chip, wireless communication chip, NFC chip or the like. The controller 140 may perform communication with the external devices described above by using the communication unit 110.

Specifically, Wi-Fi chip and Bluetooth chip perform communication according to Wi-Fi method and Bluetooth method, respectively. When Wi-Fi chip or Bluetooth chip is used, various connection information, such as SSID and session key, may be first transmitted and received, so that communication may be connected by using the connection information and various information may be transmitted and received. The wireless communication chip refers to a chip for performing communication according to various communication standards, such as IEEE, ZigBee, 3rd Generation (3G), 3rd Generation Partnership Project (3GPP), Long Term Evolution (LTE), or the like. The NFC chip refers to a chip that operates according to Near Field Communication (NFC) utilizing 13.56 MHz bandwidth among various RF-ID frequency bandwidths such as 135 kHz, 13.56 MHz, 433 MHz, 860-960 MHz, 2.45 GHz, or the like.

The display 120 may provide various content screens. In an example, content screen may include various contents such as image, video, and text, application running screen including various contents, graphic user interface (GUI) screen, or the like. According to an embodiment, the display 120 may display a message transmitted to, or received from an external device, and a translated message of the transmitted and received message for the notice of a user.

A method for implementing the display 120 is not strictly limited. For example, the display may be implemented as various forms of displays, such as liquid crystal display (LCD), organic light emitting diodes (OLED) display, active-matrix organic light-emitting diode (AM-OLED), plasma display panel (PDP), or the like. The display 120 may additionally include additional configurations depending on the method for implementing the same. For example, for a liquid display type of display 120, the display 120 may include a LCD display panel (not illustrated), a backlight unit (not illustrated) for providing light, and a panel drive substrate (not illustrated) for driving a panel (not illustrated). Specifically, according to an embodiment, the display 120 may be preferably combined with a touch sensing unit of the sensing unit 130 to be thus provided as a touch screen.

The sensing unit 130 may sense various user interactions. The sensing unit 130 may be configured to include a motion gesture sensing unit (not illustrated) and a touch gesture sensing unit (not illustrated).

The motion gesture sensing unit may include at least one of an acceleration sensor and a gyro sensor, which can sense a motion of the user terminal device 100.

Further, the touch gesture sensing unit may include a touch sensor. The touch gesture sensing unit may sense a touch input of a user, using the touch sensor attached on a back side of the display panel. The processor 140 may obtain information such as touch coordinates, touch time or the like from the touch gesture sensor to determine the type of the sensed touch input (e.g., tap gesture, double tap gesture, panning gesture, flick gesture, touch and drag gesture, and so on). Further, the touch gesture sensing unit may directly determine the type of the touch input, using the obtained touch coordinates and touch time.

The processor 140 is configured to control overall operation of the user terminal device 100.

The processor 140 may provide the translation service for at least one message among the messages displayed on the display 120, when a preset gesture is sensed by the sensing unit 130. Specifically, the processor 140 may transmit at least one message of the displayed messages to the external server for providing translation service, and when a translated message is received from the external device, control the display 120 to display the received translated message.

Specifically, the processor 140 may distinctively display the messages being transmitted and received on a message unit basis, and provide the translation service for the displayed messages on the message unit basis. In other words, the processor 140 may provide the translation service for a message selected by a user by a unit of a message box that includes word balloon, comment window or the like, based on which separately transmitted and received messages are divided and displayed.

According to an embodiment, in response to sensing a touch gesture inputted for at least one of the displayed messages, the processor 140 may control such that the message for which touch gesture is inputted is translated and the corresponding translated message in a preset language is displayed. In an example, the touch gesture for the message may be a touch and drag in one direction. The processor 140 may control the display 120 to replace the message for which the touch gesture is inputted with a translated message, or display the translated message together with the message for which the touch gesture is inputted.

According to another embodiment, in response to sensing a motion gesture inputted to the user terminal device 100, the processor 140 may control the display 120 to translate all of displayed messages into a preset language and display the result. In an example, the motion gesture may be various motions of the user terminal device 100 including rotating movement, linear movement, reciprocal movement such as shaking, and so on.

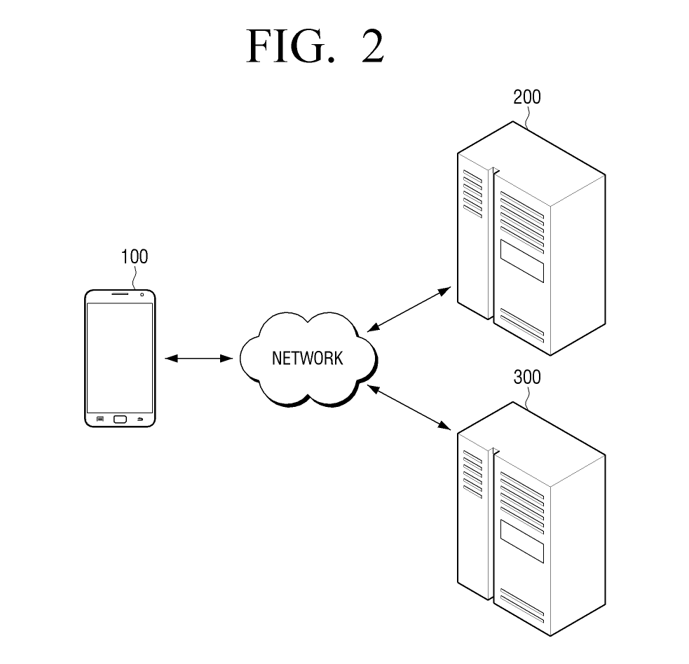

FIG. 2 is a diagram illustrating a system in which a user terminal device in a communication with an external server performs translation.

A network 20 may include a messaging service providing server 200 and a translation service providing server 300.

The network 20 may be a single network or a combination of networks, which may wirelessly connect the translation service providing server 300, the user terminal device 100, and the messaging service providing server 200 for mutual communication of message-related data.

The user terminal device 100 according to an embodiment may be generally implemented as a small-sized device such as a smartphone, and so on, and accordingly, has a limit in storing data in the user terminal device 100 in view of a memory capacity. Therefore, the user terminal device 100 according to an embodiment may be provided with the translation data from the translation service providing server 300 via the communication unit 110.

The translation service providing server 300 may receive a selected message from the user terminal device 100 and perform translation of the received message. Specifically, the translation service providing server 300 may perform translation of a source message to be translated based on the translation data included in a translation DB loaded therein and transmit a translated message to the user terminal device 100. In an example, the translation DB may store data for performing translation according to various national languages. The user terminal device 100 may transmit language setting information in which a target national language of the translation is set, when transmitting a source message to be translated to the translation service providing server 300. For example, a user may set at the user terminal device 100 a Korean language as a target language into which a message is to be translated, in which case, the language setting information may be transmitted together when a source message to be translated is transmitted. The translation service providing server 300 may perform translation according to the target language of the translation based on the received language setting information.

The messaging service providing server 200 is a mobile carrier server, which provides the messaging service. The messaging service providing server 200 may include at least one among a server for relaying transmission of messages, such as short messaging service, multimedia messaging service or the like, a server for relaying transmission of messages by mobile messenger service, and a server for providing social network service.

The user terminal device 100 may transmit and receive a message with the counterpart user terminal device through the messaging service providing server 200 or transmit a message to a server for providing social network service.

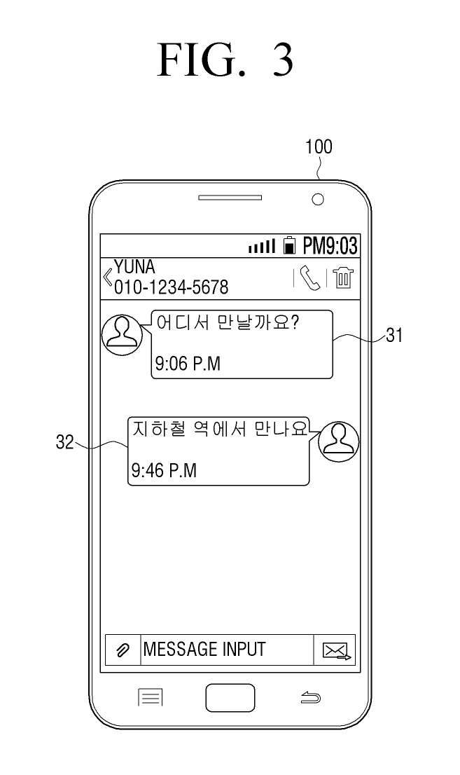

FIGS. 3 to 5 are diagrams provided to explain a touch gesture for translating a message according to an embodiment.

As illustrated in FIG. 3, a user may execute a messaging application on the user terminal device 100 and view a received message on the user terminal device 100, and then write a message and transmit it to the counterpart user terminal device.

Generally, a messaging application may distinctively display each of the separately transmitted and received messages, as illustrated in FIG. 3. The messages being transmitted and received may be distinguished by message boxes 31, 32 that encircle each of the messages.

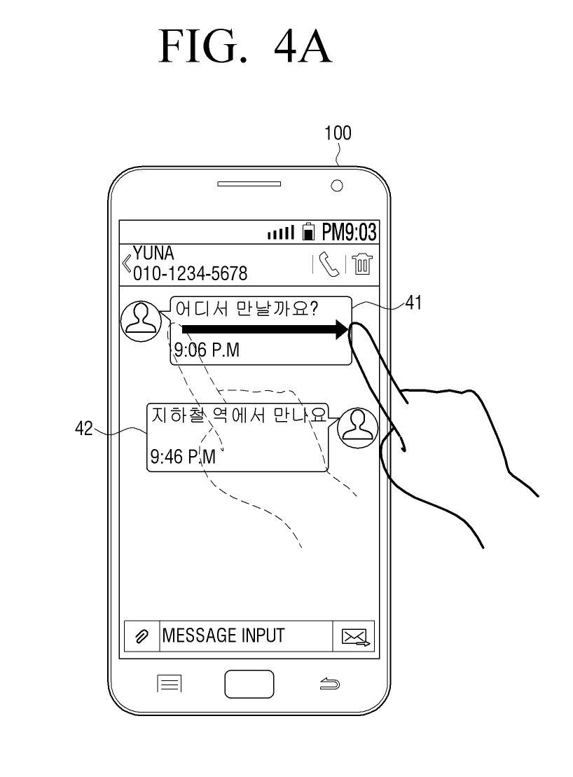

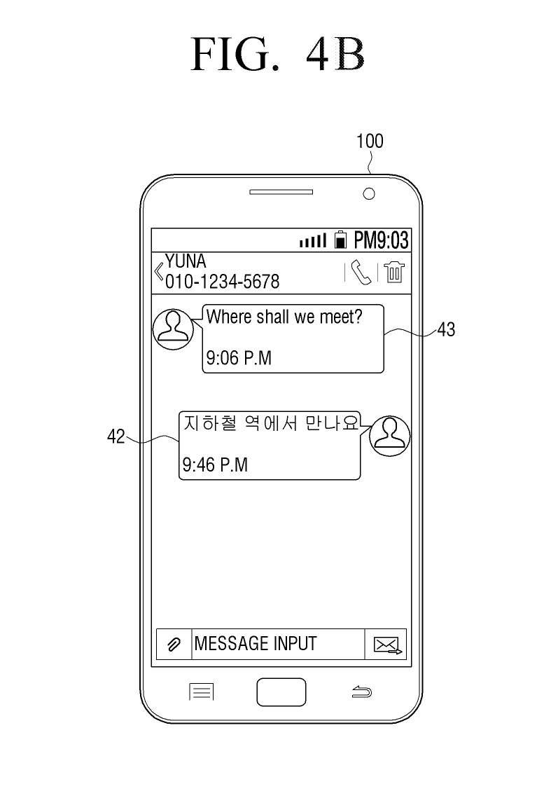

As illustrated in FIG. 4a, the user may perform a preset touch gesture with respect to a message 41 that is intended to be translated so that the message 41 is translated. In an example, a target language of the translation may be set or modified by an option menu provided from a messaging application or the user terminal device 100.

When the user performs a touch and drag with respect to the message 41 in a direction from left to right, the message 41 may be translated into a preset national language. In other words, a unit of translation may correspond to a message box unit of distinguishing the messages being transmitted and received.

FIG. 4b illustrates a screen displaying a translated message for which the tough gesture is inputted. When a preset target language is English, the user terminal device 100 may transmit the message 41 “ [symbol] ?” for which the gesture is inputted to the translation service providing server 300, and receive a translated message 43 “Where shall we meet?” from the translation service providing server 300. In an example, the user terminal device 100 may transmit target language setting information (English) together with the message for which the gesture is inputted.

The user terminal device 100 may replace the message 41 for which touch gesture is inputted into the translated message 43 and display the translated message 43 as illustrated in FIG. 4b.

According to another embodiment, the user terminal device 100 may additionally display the translated message “Where shall we meet?” together with the source message “ [symbol] ?” for which touch gesture is inputted. For example, the user terminal device 100 may divide a region of the message box for which touch gesture is inputted or additionally generate another message box under the message box, and display the translated message “Where shall we meet?” in the divided message box region or the additionally generated message box.

According to another embodiment, when the user terminal device 100 additionally includes a speaker and the user performs a preset touch gesture with respect to the message for which the touch gesture is inputted or with respect to the translated message, the processor 140 may convert the translated message into voice and output the converted voice through the speaker. In this case, the communication unit 110 may transmit the translated message to a text to speech (TTS) server for converting text into voice, and receive the converted voice signal of the translated message from the TTS server.

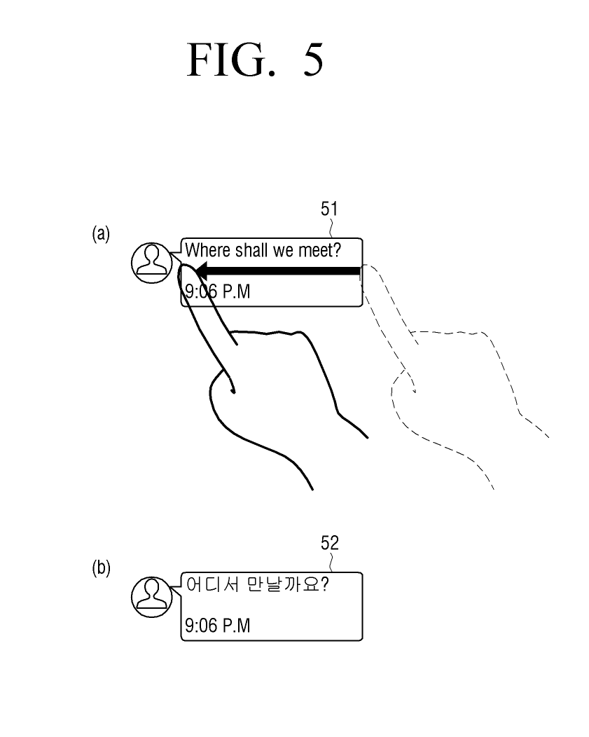

Meanwhile, according to an embodiment, the translated message may be un-translated into the source message as illustrated in FIG. 5. Specifically, in response to sensing a preset touch gesture inputted for the translated message 51, the processor 140 may control such that the source message 52 before translation is displayed instead of the translated message 51 for which the touch gesture is inputted.

In an example, the touch gesture to un-translate the translated message 51 back into the source message 52 may be a gesture in an opposite direction to the touch gesture performed to translate the source message 52. For example, the touch gesture for translating the received source message before translation may be a touch and drag in a first direction, and the touch gesture for un-translating the translated message back into the source message before translation may be a touch and drag in a second direction opposite the first direction.

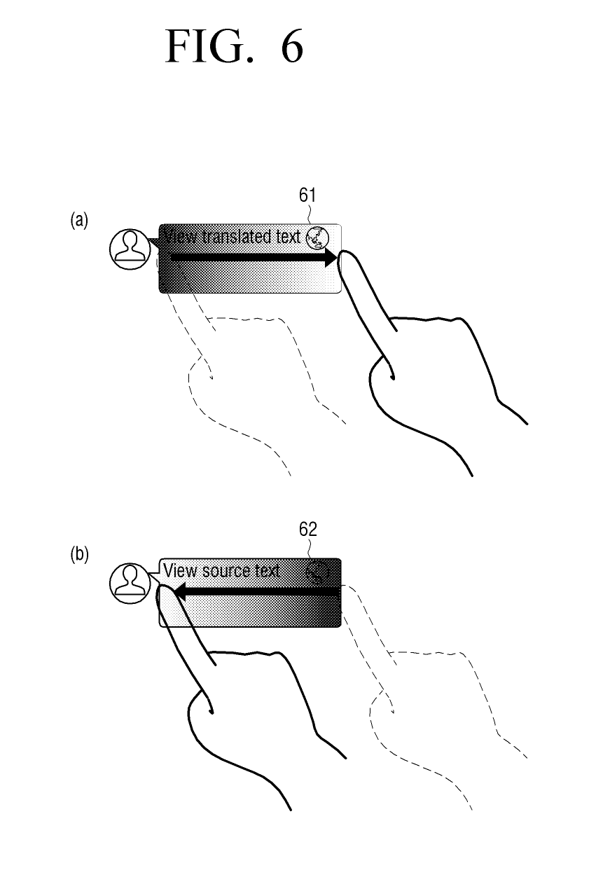

FIG. 6 is a diagram provided to explain a touch gesture for translating a message according to another embodiment.

According to another embodiment, when a preset gesture, e.g., a touch and drag in a direction from left to right in FIG. 6a, is inputted for the source message 41 to be translated, the user terminal device 100 may display an instruction statement to inform about an operation to be performed according to touch and drag (e.g., “View translated text 61”) upon inputting of the touch and drag. In an example, when touch and drag in a direction from left to right is not complete, translation of the corresponding message may not be performed. When the touch and drag is complete, the instruction statement disappears and a translated text for the message may be displayed.

Likewise, as illustrated in FIG. 6b, an instruction statement such as “View source text 62” may be displayed while a touch and drag is being inputted in a direction from right to left with respect to the translated message. When touch and drag is complete, the instruction statement may disappear and the source message of the translated message may be displayed.

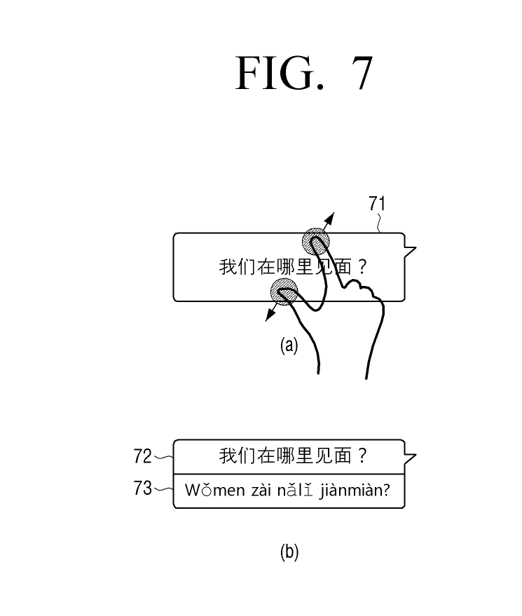

FIG. 7 is a diagram provided to explain a method for displaying pronunciation information of a message according to an embodiment.

Referring to FIG. 7, the processor 140 may control such that pronunciation information of any of the messages displayed on the display 120 is displayed. Specifically, when the user performs a preset touch gesture for a message having pronunciation information, the processor 140 may display the pronunciation information such as phonetic alphabets of corresponding message. In an example, the pronunciation information may be additional information displayed together with corresponding message.

For example, as illustrated in FIG. 7a, when the user performs pinch-out gesture with respect to a message in Chinese language, the processor 140 may display phonetic alphabets of such Chinese language message. In an example, as illustrated in FIG. 7b, a region of a message box 71 for which gesture is inputted may be divided in response to the pinch-out gesture, and a Chinese language message 72 along with the phonetic alphabets 73 of the Chinese language message may be displayed in each of the divided regions.

In an example, Chinese pronunciation information may be information stored in the user terminal device 100. Alternatively, the processor 140 may transmit a message for which gesture is inputted to the translation service providing server 300, and receive and display pronunciation information of the message from the translation service providing server 300.

In an example, the user terminal device 100 may further include the speaker such that, when preset touch gesture is inputted for the pronunciation information, the processor 140 may convert the pronunciation information for which touch gesture is inputted into voice and output the converted voice through the speaker. For example, when a user double-touches the region displaying the pronunciation information 73 of the Chinese language message, the speaker may output voice according to pronunciation information.

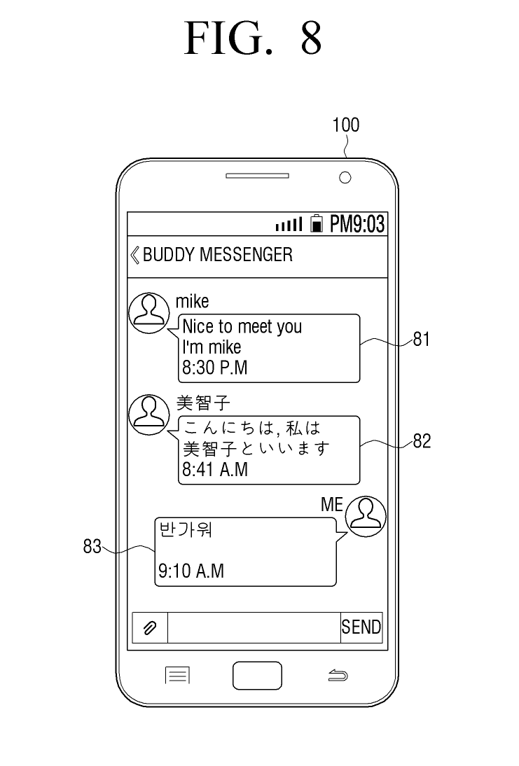

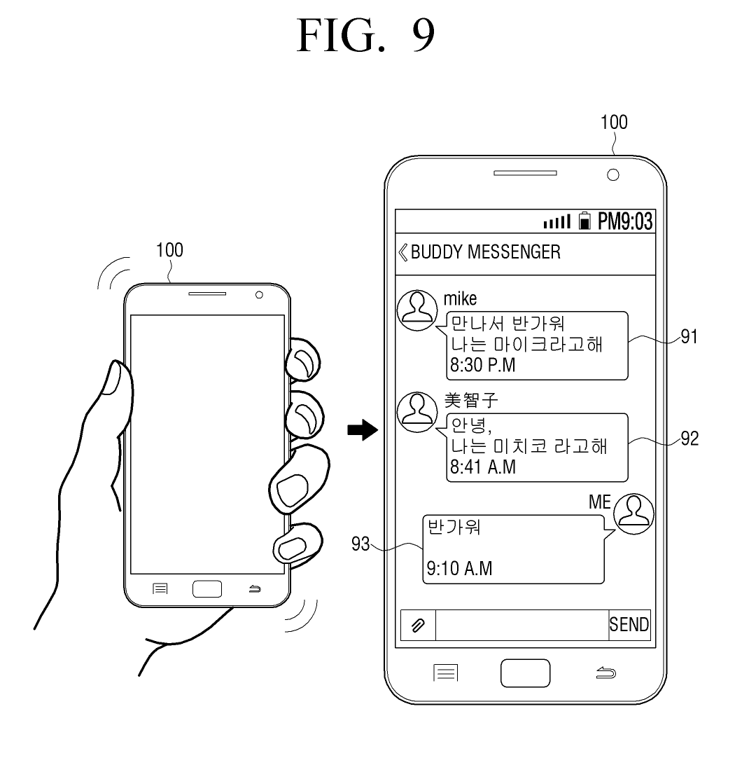

FIGS. 8 and 9 are diagrams provided to explain a motion gesture for translating all of displayed messages according to an embodiment.

Referring to FIG. 8, a user may have a conversation with a single user or a plurality of users using a mobile messenger. In an example, the mobile messenger includes commercial messenger applications such as Kakao Talk, Line, WhatsApp, or the like.

FIG. 8 illustrates an embodiment in which a user transmits and receives messages at real time among a plurality of users including “Mike” who uses English language and “Michiko” who uses Japanese language. In an example, when each of the users transmit a message in different languages from each other, real-time translation with respect to the messages may be performed in response to a preset gesture performed for each of the messages. In an example, when a target language of the translation is set to be Korean, both the English language message 81 and the Japanese language message 82 may be translated into Korean language messages.

Accordingly, without having to perform a separate application for translation such as translation application, the users may actively communicate without having a pause in their conversation because screen with messages in translated languages is available to be viewed on a corresponding messaging application.

Meanwhile, the user may perform a preset motion gesture on the user terminal device 100 to view each of the translated messages of all the messages displayed on the display 120. For example, as illustrated in FIG. 9, when the user performs a motion of grabbing and shaking the user terminal device 100, the processor 140 may translate the messages in foreign language 81, 82 for which translation is available, among the messages displayed on the display 120 in preset languages, and replace the messages 81, 82 with the translated target messages 91, 92 and display the translated target messages 91, 92. In an example, the processor 140 may transmit all the displayed foreign-language messages 81, 82 to the translation service providing server 300, and receive and display corresponding translated messages 91, 92.

As a result, the user may translate all of displayed messages into preset national languages by simply performing one motion gesture without having to individually perform a touch gesture with respect to each of the messages.

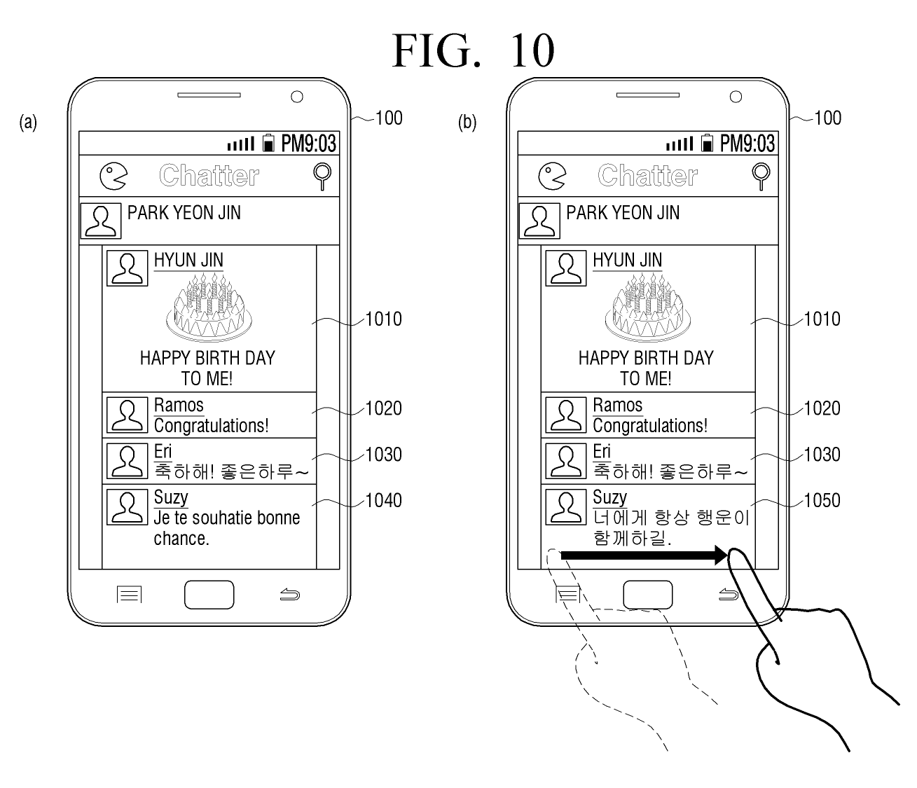

FIG. 10 is a diagram provided to explain a touch gesture for translating a message posted on the social network service according to an embodiment.

Referring to FIG. 10, real-time translation may be performed with respect to a message such as article posted on a mobile page or comments thereof provided through the social network service (SNS). In an example, SNS includes online services such as Facebook or Twitter for building up a relation network of internet users on online. The SNS may be executed on the user terminal device 100 using an SNS providing application as a platform.

FIG. 10a illustrates screen in which the user terminal device 100 connects to SNS. As illustrated in FIG. 10a, SNS may be configured with basic platform including a posted message 1010 and comment type messages 1020-1040 thereof. In an example, the posted message 1010 and comment messages 1020-1040 may be distinctively displayed on a message unit basis, in which case each of the messages may be translated on the message unit basis.

For example, as illustrated in FIG. 10b, the user may perform a touch and drag gesture with respect to one (e.g., message 1040) of the comment messages 1020-1040, and the message 1040 for which touch and drag gesture is inputted may be replaced by a translated message 1050 in a preset target language and displayed.

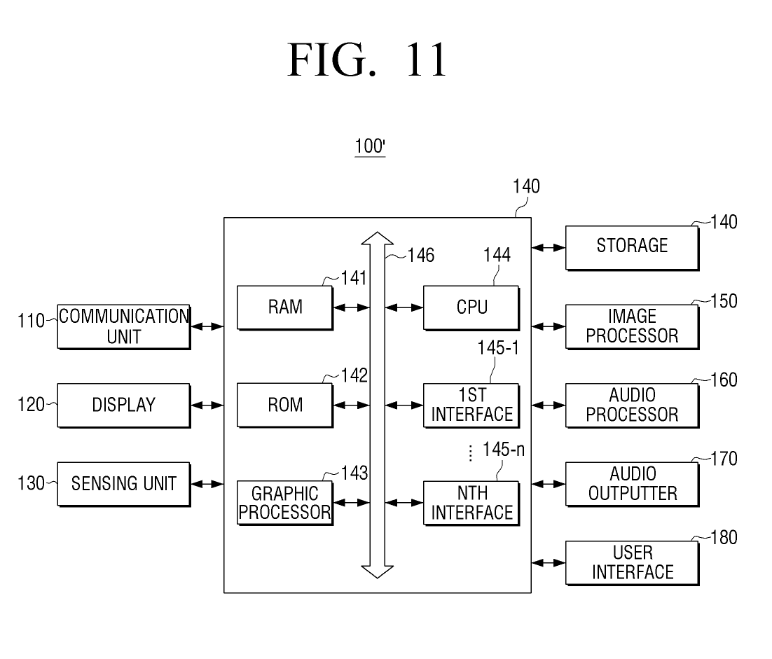

FIG. 11 is a block diagram illustrating a constitution of a user terminal device in detail according to another embodiment. As illustrated in FIG. 11, the user terminal device 100′ according to another embodiment includes a communication unit 110, a display 120, a sensing unit 130, a processor 140, a storage 150, an image processor 160, an audio processor 170, an audio outputter 180 and a user interface 190. In the following description, elements or operations overlapping with those described above with reference to FIG. 1 will not be redundantly described for the sake of brevity.

The processor 140 includes RAM 141, ROM 142, a graphic processor 143 (CPU 144, first to nth interfaces 145-1 to 145-n) and a bus 146. In an example, RAM 141, ROM 142, and the graphic processor 143 (CPU 144, first to nth interfaces 145-1 to 145-n) may be connected to each other via the bus 146.

The first to nth interfaces 145-1 to 145-n are connected to the elements described above. One of the interfaces may be a network interface connected to an external device through network.

The CPU 144 may access the storage 140 and perform booting by using O/S stored in the storage 140. Further, the CPU 144 may perform various operations by using various programs, contents and data stored in the storage 140.

The RAM 141 stores instruction sets for system booting. Upon powering-on in response to input of turn-on command, the CPU 144 copies RAM 141 stored in the storage 150 onto the RAM 141 according to the instructions stored in the ROM 142, and executes the O/S to boot the system. When the booting is completed, the CPU 144 copies various application programs stored in the storage 150 onto the RAM 141, and executes the application program copied to the RAM 141 to perform various operations.

The graphic processor 143 may generate a screen including various objects such as icons, images, texts or the like, using an arithmetic unit (not illustrated) or a renderer (not illustrated). The arithmetic unit calculates attribute values such as coordinate values, forms, sizes, colors or the like according to layouts of screens. The renderer may generate various layouts of screens including objects based on the attribute values calculated at the arithmetic unit.

Meanwhile, the operation of the processor 140 described above may be performed by implementing the programs stored in the storage 150.

The storage 150 may store O/S (operating system) software module for driving the user terminal device 100′ and various multimedia contents.

Specifically, the storage 150 may store a base module for processing signals delivered from each hardware included in the user terminal device 100′, a storage module for managing database (DB) or registry, a graphic processing module for generating layouts of screens, a security module or the like. Specifically, the storage 150 may store programs such as communication module, translation module or the like, which are necessary for implementation of the translation service according to an embodiment.

The processor 140 may perform communication with the counterpart user terminal device 200, the messaging service providing server 300, the translation service providing server 300 or the like by using the communication module.

The image processor 160 is configured to process various images such as decoding, scaling, noise filtering, frame rate converting, resolution converting or the like with respect to contents.

The audio processor 170 is configured to process audio data. Specifically, the audio processor 170 may process the pronunciation information for which touch gesture is inputted to convert it into voice data, and deliver the converted voice data to the audio outputter 180.

The audio outputter 180 is configured to output audio data processed in the audio processor 170. The audio outputter 180 may output the converted voice data through a receiver or a speaker.

The user interface 190 is configured to sense user interaction for controlling overall operation of the user terminal device 100′.

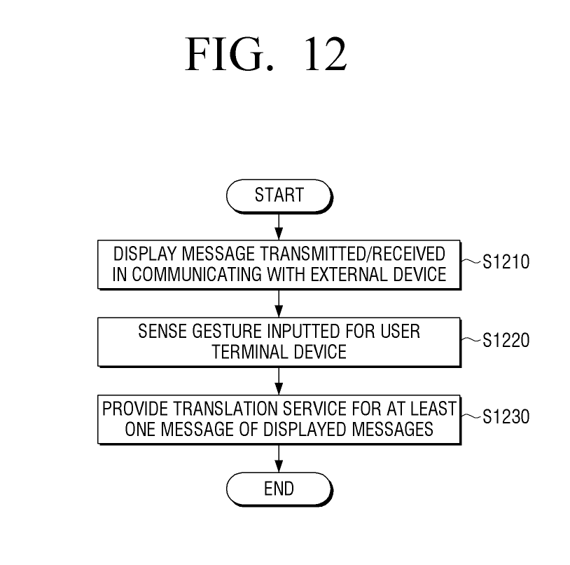

FIG. 12 is a flowchart provided to explain a control method of a user terminal device according to an embodiment.

First, the user terminal device may control such that a message transmitted and received in a communication with an external device is displayed, at S1210. In an example, the messages being transmitted and received may be distinctively displayed on a message unit basis.

At S1220, a gesture for the user terminal device may be sensed. In an example, the gesture inputted for a message may be a touch and drag in a first direction. Further, a touch gesture inputted for the translated message of the message may be a touch and drag in a second direction opposite the first direction.

At S1230, when gesture is sensed, the user terminal device may provide the translation service for at least one of the displayed messages. In an example, translation service for the displayed messages may be provided on a message unit basis. Further, in response to sensing a touch gesture inputted for at least one of the display messages, it may be controlled such that the message for which touch gesture may be inputted is translated and the corresponding translated message in a preset language may be displayed. Further, in response to sensing a touch gesture inputted for the translated message, it may be controlled such that the translated message for which touch gesture is inputted may be un-translated back into the source message before translation.

In an example, it may be controlled such that the message for which touch gesture is inputted may be replaced by the translated message and displayed. Further, it may be controlled such that the message for which touch gesture is inputted may be displayed together with the translated message.

Further, in response to sensing a touch gesture inputted for the translated message, pronunciation information with respect to the translated message for which touch gesture is inputted may be displayed.

According to various embodiments of the present disclosure described above, messages transmitted and received among user terminal devices may be instantly translated. Accordingly, communication between users using different languages from each other may be performed more actively.

The control method of the user terminal device according to the various embodiments described above may be implemented as a program and stored in various recording media. In other words, a computer program processible with various processors for implementing various control methods described above may be stored in recording media and used.

For example, a non-transitory computer readable recording medium may be provided, storing therein a program for performing operations of displaying a message transmitted and received in a communication with an external device, sensing a gesture inputted for the user terminal device, and providing translation service for at least one of the displayed messages.

The non-transitory computer readable medium is a medium capable of storing data semi-permanently and being readable by a device, rather than a medium such as register, cash, and memory that stores the data for a brief period of time. In particular, the various applications or programs described above may be stored and provided on a non-transitory computer readable medium such as CD, DVD, hard disk, Blu-ray disk, USB, memory card, ROM, and so on.

Further, while the present disclosure has been described in detail above, it should be understood that the detailed description and specific examples, while indicating preferred embodiments of the disclosure, are given by way of illustration only, since various changes and modifications within the scope of the disclosure will become apparent to those skilled in the art from this detailed description.

1. A user terminal device for providing a translation service, comprising:
a communication unit configured to perform communication with an external device;
a display configured to display messages transmitted and received in a communication with the external device;
a sensing unit configured to sense a gesture for the user terminal device; and a processor configured to provide the translation service for at least one of the displayed messages when a preset gesture is sensed.

2. The user terminal device of claim 1, wherein the processor is further configured to control to:
distinctively display the transmitted and received messages on a message unit basis, and
provide translation service for the displayed messages on the message unit basis.

3. The user terminal device of claim 1, wherein, in response to a touch gesture for at least one of the displayed messages being sensed, the processor is further configured to control such that a translated message of the message for which touch gesture is inputted is displayed in a preset language.

4. The user terminal device of claim 3, wherein, in response to a touch gesture for the translated message being sensed, the processor is further configured to control such that the translated message for which the touch gesture is inputted is displayed in a source language before the translation.

5. The user terminal device of claim 4,
wherein the touch gesture for the message is a touch and drag in a first direction, and
wherein the touch gesture for the translated message is a touch and drag in a second direction opposite the first direction.

6. The user terminal device of claim 3, wherein the processor is further configured to control such that, the message for which the touch gesture is inputted is replaced by the translated message and displayed, or the translated message is displayed together with the message for which the touch gesture is inputted.

7. The user terminal device of claim 3, wherein, in response to a touch gesture for the translated message being input, the processor is further configured to control such that a pronunciation information is displayed for the translated message for which the touch gesture is inputted.

8. The user terminal device of claim 7, further comprising:
a speaker,
wherein, in response to a touch gesture with respect to the pronunciation information being input, the processor is further configured to:
convert the pronunciation information for which the touch gesture is inputted into voice, and
output the converted voice through the speaker.

9. The user terminal device of claim 1, wherein, in response to a motion gesture for the user terminal device being sensed, the processor is further configured to control such that all of the displayed messages are translated into a preset language and displayed.

10. The user terminal device of claim 1,
wherein the communication unit is further configured to perform communication with an external server for providing translation service, and
wherein the processor is further configured to control such that at least one of the displayed messages is transmitted to the external server, and a translated message of the at least one message received from the external server is displayed.

11. A control method of a user terminal device for providing a translation service, comprising:
displaying messages transmitted and received in a communication with an external device;
sensing a gesture for the user terminal device; and
providing the translation service for at least one of the displayed messages.

12. The control method of claim 11,
wherein the displaying comprises distinctively displaying the transmitted and received messages on a message unit basis, and
wherein the providing of the translation service comprises providing the translation service for the displayed messages on a message unit basis.

13. The control method of claim 11, wherein, in response to a touch gesture for at least one of the displayed messages being sensed, the providing of the translation service comprises displaying a translated message of the message for which touch gesture is inputted, in a preset language.

14. The control method of claim 13, wherein, in response to a touch gesture for the translated message being sensed, the providing of the translation service comprises displaying the translated message for which the touch gesture is inputted in a source language before translation.

15. The control method of claim 14,
wherein the touch gesture inputted for the message is a touch and drag in a first direction, and
wherein the touch gesture inputted for the translated message is a touch and drag in a second direction opposite the first direction.
